(19) United States
(12) Patent Application Publication
(10) Pub. No.: US 2007/0236976 A1
(43) Pub. Date: Oct. 11, 2007

(54) Open loop single output high efficiency AC-DC regulated power supply

(76) Inventor: Randhir S. Malik, Cary, NC (US)

Correspondence Address: DILLON & YUDELL LLP, 8911 N. CAPITAL OF TEXAS HWY.,, SUITE 2110, AUSTIN, TX, 78759, US

(21) Appl. No.: 11/400,418

(22) Filed: Apr. 7, 2006

(51) Int. Cl. H02M 7/04

(52) U.S. Cl. 363/89

(57) ABSTRACT

Disclosed is a circuit design and method for providing an open loop, single-output, high efficiency AC-DC regulated power supply. The circuit is designed with two boost stages (or a two-stage boost) coupled to a zero-voltage switched (ZVS) synchronous rectifier. The first boost stage comprises an inductive switching component coupled to a first capacitor and a pulse width modulator (PWM) via a diode and transistor, respectively. The second boost stage comprises the inductive component coupled to a MOSFET, diode, and capacitor. The second boost state runs at substantially 50% duty cycle for low line conditions and substantially 10% duty cycle for high line conditions, whereby the overall efficiency of the two-stage boost is substantially equal to a conventional boost stage. The circuit includes a DC-DC regulator section, which operates in ZVS mode at approximately 100% duty cycle.

### BACKGROUND OF THE INVENTION

1. Technical Field

The present invention is directed to power supplies and specifically to AC-DC power supplies. Still more particularly, the present invention relates to a method and circuit device for increasing the efficiency of an AC-DC regulated power supply.

2. Description of the Related Art

Desired characteristics of single-output power supplies include high efficiency and low profile, among others. Conventional designs of these single-output power supplies, however, utilize high voltage rated devices on the secondary side and high voltage second inductors to regulate the output voltage provided. Also, with conventional designs, the bulk capacitor required to meet the holdup requirement of the device is relatively large.

### SUMMARY OF THE INVENTION

Disclosed is a circuit design and method for providing an open loop, single-output, high efficiency AC-DC regulated power supply. The circuit is designed with two boost stages (or a two-stage boost) coupled to a synchronous rectifier. The first boost stage comprises an inductive switching component (cross-coupled inductor L1) coupled to a first capacitor C1 and a pulse width modulator (PWM) via a diode D1 and transistor Q3, respectively. The second boost stage comprises the inductive component L1 coupled to a MOSFET Q4, and diode D2 and capacitor C2. The synchronous rectifier is a zero voltage switched (ZVS) synchronous rectifier.

In one embodiment, the first boost stage may be regulated to 200V when the AC line voltage is low (e.g., 100 Vac). This regulating of the first boost stage voltage to 200V improves the efficiency of the boost stage because of lower conduction duty ratio of the switching MOSFET. The second boost stage runs at substantially 50% duty cycle for low line conditions and substantially 10% duty cycle for high line conditions. Therefore, the overall efficiency of the two-stage boost is substantially equal to a conventional boost stage.

The circuit includes a DC-DC regulator section, which operates in zero voltage switched (ZVS) mode at approximately 100% duty cycle. Thus, at 100% duty cycle operation, this DC-DC regulator section requires a very small inductor and a capacitor for filtering. The bulk capacitor required to meet the holdup requirement of the circuit device is relatively very small when compared to conventional/existing designs.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram representation of a power supply circuit designed with two boost stages according to one embodiment of the invention.

### DETAILED DESCRIPTION OF AN ILLUSTRATIVE EMBODIMENT

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention provides a circuit design and method for providing an open loop, single-output, high efficiency AC-DC regulated power supply. The circuit is designed with two boost stages (or a two-stage boost) coupled to a synchronous rectifier.

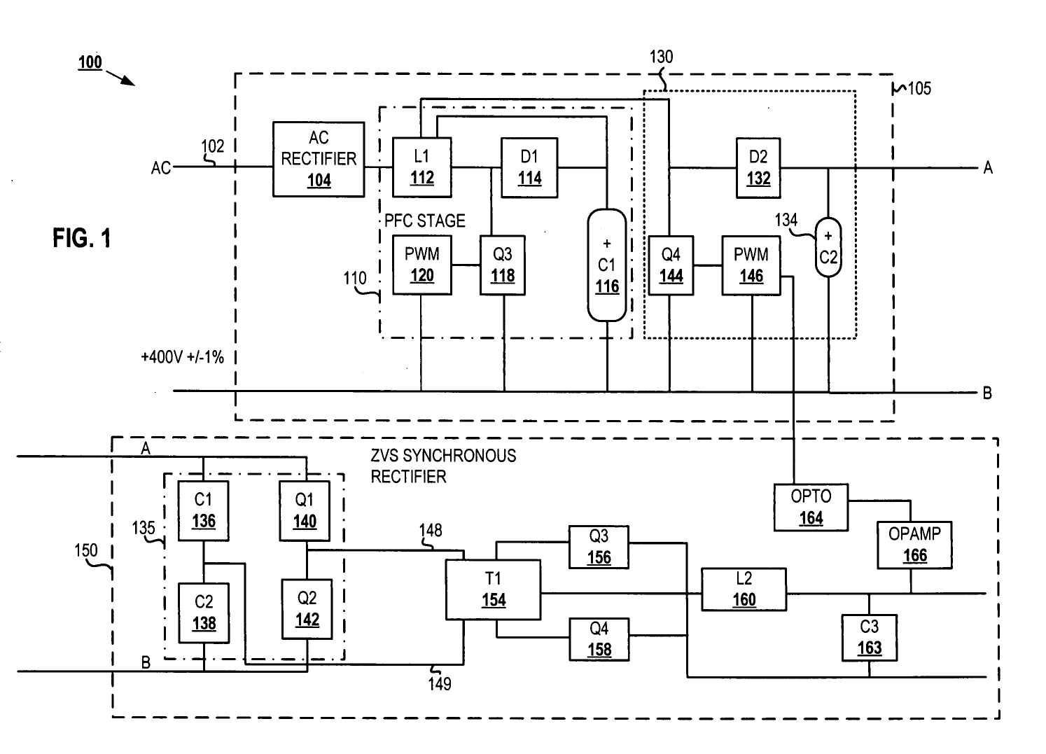

With specific reference now to FIG. 1, there is illustrated an example circuit design according to the invention. The circuit 100 consists of three power stages, of which two are boost stages, first boost stage 110 and second boost stage 130, and the third is a synchronous rectifier 150. The first boost stage 110 comprises an inductive switching component (L1) 112 with output (cross-coupled winding) coupled to diode (D1) 114, which is in turn coupled to first capacitor (C1) 116. L1 112 is further connected to transistor (Q3) 118, which is connected to pulse width modulator (PWM) 120. First boost stage 110 receives an alternating current (AC) input 102, which is passed through an AC rectifier 104 before being fed into L1 112. First boost stage provides a power factor correction (PFC) stage of circuit 100.

The second boost stage 130 comprises cross-coupled winding of L1 112 coupled to second diode (D2) 132, which is in turn coupled to capacitor (C2) 134. In addition to diode D2 132 and capacitor C2 134, second boost stage 130 comprises transistor (Q4) 144 connected to PWM 146 and cross-coupled winding of L1 112.

The DC-DC regulator primary side of rectifier circuit 150 comprises ½H bridge 135 consisting of capacitors C1 136 and C2 138 and MOSFETS 140 and 142. The final boost voltage developed across the capacitor (C2) 134 is chopped by the ½H bridge 135 and applied at input nodes 148 and 149 of transformer 154. Outputs of ½H rectifier 135 are coupled to inputs 148, 149 of transformer (T1) 154 within synchronous rectifier 150. Outputs of T1 154 are connected to transistors (Q3 156 and Q4 158) as well as to inductor (L2) 160. Outputs of Q3 156 and Q4 158 are joined and connected to lower terminal of capacitor (C3) 162, whose other terminal is connected to the output from L2 160.

PWM 146 of second boost stage 130 receives an output of OPTO 164 which in turn is fed by OP AMP 166. OP AMP 166 generates an output error voltage that is proportional to the voltage developed at a junction of C3 163 and L2 160.

Operation of the above configured circuit provides specific characteristics, which are now described. In one embodiment, the first boost stage 110 may be regulated to 200V when the AC line voltage (input voltage 102) is low (e.g., 100 V_{ac}). This regulating of the first boost stage's voltage to 200V improves the efficiency of the first boost stage 100 because of lower conduction duty ratio of the switching MOSFET Q3 118. The second boost stage 130 runs at approximately 50% duty cycle for low line conditions and approximately 10% for high line conditions (e.g. 200V). The overall efficiency of the two-stage boost is substantially equal to a conventional single boost stage.

Also, in one embodiment, the synchronous rectifier 150 is a zero-voltage switched (ZVS) synchronous rectifier. The circuit 100 thus includes a DC-DC regulator section (within rectifier 150), which operates in ZVS mode at approximately 100% duty cycle. At 100% duty cycle operation, this DC-DC regulator section requires a very small inductor and a capacitor for filtering. Inductor L2 160 and capacitor C3 163 are designed accordingly. Finally, the bulk capacitor required to meet the holdup requirement of the circuit device 100 is relatively very small when compared to conventional/existing designs.

In operation, the DC-DC regulator stage provides an open loop 100% duty ratio ½H bridge 135 consisting of capacitors 136, 137 and MOSFETS 140, 142, with synchronous rectifier consisting of MOSFETS 156, 158, inductor 160 and capacitor 163. First boost stage 110 consists of L1, Q3, D1, C1 and a PWM for controlling the boost voltage and providing the power factor correction. The second boost stage 130 uses the cross field inductor L1, Q4, D2 and C2, and the voltage across C1 is boosted to 400V. Both boost stages (110, 130) operate in zero-current switching (ZCS) mode to reduce losses.

Then, the 400V bulk across capacitor C2 134 is applied to the ½H bridge 135 that operates in 100% ZVS mode. The size of the transformer T1 154 is minimized because of very low losses due to 100% operation. Transistors Q3 156 and Q4 158 are the output MOSFETs, and are rated at 30V and operate in synchronous rectification mode. The filter inductor is very small (e.g., <1 uH) because of 100% duty cycle operation. Also, capacitor C2 134 may be ceramic in design because of very low ripple current. The output voltage is regulated against output load variation by varying the input voltage to the ½H bridge. Thus at a slight degradation of efficiency at boost stage, there is a 3%-4% gain in the DC-DC stage because of 100% duty cycle operation.

While the invention has been particularly shown and described with reference to a preferred embodiment, it will be understood by those skilled in the art that various changes in form and detail may be made therein without departing from the spirit and scope of the invention.

What is claimed is:

1. An open loop, single-output, high efficiency AC-DC regulated power supply circuit comprising:
three power stages comprising a first boost stage sequentially coupled a second boost stage, whose output is coupled to a third synchronous rectifier stage; and
circuit design means for enabling the coupling of the three boost stages to provide a single output AC-DC regulated power supply exhibiting 100% zero voltage switched (ZVS) operating mode.

2. The circuit of claim 1, wherein the first boost stage comprises:
an inductor (L1) 112 with cross-coupled winding coupled to a diode (D1) 114 and to a transistor (Q3) 118;
a first capacitor (C1) 116 coupled to the diode D1 114; and
a pulse width modulator (PWM) 120 coupled to the transistor Q3;
wherein first boost stage operates in zero current switching (ZCS) mode and provides a power factor correction (PFC) stage of the circuit.

3. The circuit of claim 2, wherein the first boost stage further comprises:
an alternating current (AC) input, wherein the AC input is first passed through an AC rectifier 104 coupled to an input of the inductor L1.

4. The circuit of claim 1, wherein the second boost stage comprises:
a second diode (D2) 132 with input coupled to cross-coupled winding of inductor L1;
a capacitor (C2) 134 coupled to the output of second diode D2 and across which a provides final boost voltage is developed;
a transistor (Q4) 144 also coupled to inductor L1; and
a second PWM 146 coupled to transistor Q4;
wherein said second boost stage operates at ZCS mode and operates at substantially 50% duty cycle for low line conditions and substantially 10% duty cycle for high line conditions to effect an overall efficiency of the first and second boost stages.

5. The circuit of claim 1, wherein the synchronous rectifier is a ZVS synchronous rectifier and comprises:
a DC-DC regulator, which operates in ZVS mode at substantially 100% duty cycle, said DC-DC regulator comprising a small inductor and a capacitor for filtering.

6. The circuit of claim 1, wherein said DC-DC regulator of the rectifier comprises:
a ½H bridge 135 comprising capacitors C1 136 and C2 138 and MOSFETS 140 and 142; and
a transformer T1 154 with inputs coupled to the output of the ½H bridge;
wherein the ½H bridge chops a final boost voltage developed across capacitor (C2) 134 of the second boost stage and the chopped voltage is applied at input nodes of the transformer 154; and
wherein an output voltage of the circuit is regulated against output loads that may be applied to the circuit by varying an input voltage to the ½H bridge.

7. The circuit of claim 6, wherein the rectifier further comprises:
transistors Q3 156 and Q4 158 and an inductor L2 160, each coupled to an output of transformer T1;
a capacitor C3 162, with a first terminal coupled to a both outputs of transistors Q3 and Q4 and a second terminal connected to the output terminal of inductor L2.

8. The circuit of claim 7, wherein the rectifier further comprises:
an OP AMP 166 coupled to a node connecting capacitor C3 and inductor L2 and which generates an output error voltage that is proportional to the voltage developed at a node connecting capacitor C3 and inductor L2; and
an OPTO 164 coupled to an output of OP AMP and which receives an input from OP AMP 166 and provides an output to PWM 146 of second boost stage.

9. A method for manufacturing a circuit that exhibits the characteristics of the circuit of claim 1.

10. A computer system having therein a circuit designed according to claim 1.
